(19) United States
(12) Patent Application Publication
(10) Pub. No.: US 2016/0200358 A1
(43) Pub. Date: Jul. 14, 2016

(54) METHODS AND SYSTEMS FOR CONTROLLING STEERING SYSTEMS OF VEHICLES

(71) Applicant: GM GLOBAL TECHNOLOGY OPERATIONS LLC, Detroit, MI (US)

(72) Inventors: STEPHEN R. PASTOR, FARMINGTON HILLS, MI (US); MICHAEL C. GAUNT, METAMORA, MI (US)

(21) Appl. No.: 14/596,802

(22) Filed: Jan. 14, 2015

(51) Int. Cl. B62D 15/02; B62D 5/04

(52) U.S. Cl. CPC B62D 15/025; B62D 5/046; B62D 15/0285

(57) ABSTRACT

Methods and systems are provided for controlling a steering system of a vehicle. A method includes: determining that an automated steering event is occurring; and minimizing motion of a hand wheel of the steering system by controlling, by a control module, a motor of an active steering system.

### TECHNICAL FIELD

The present disclosure generally relates to vehicles, and more particularly relates to methods and systems for controlling steering systems of vehicles.

### BACKGROUND

Electric Power Steering (EPS) systems use an electric motor to assist the driver of a vehicle when steering. For example, sensors detect a position and torque of the steering column, and a computer module controls a motor such that the assistive torque is applied by the motor. The computer module can apply varying amounts of assistance depending on driving conditions.

Some automated systems, such as active safety crash avoidance systems, make use of the EPS system to automatically steer the road wheels in a given direction to avoid the crash. Other automated systems, such as park assist systems, make use of the EPS system to automatically steer the road wheels to park the vehicle. In some instances, the automated systems steer the road wheels at high rates for example to avoid the crash, or to make a sharp turn. In doing so, the hand wheel moves at a correspondingly high rate of speed. Such movement can be unexpected by a driver.

Accordingly, it is desirable to provide improved methods and system for controlling steering systems of vehicles during automated steering procedures. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for controlling a steering system of a vehicle. In one embodiment, a method includes: determining that an automated steering event is occurring; and minimizing motion of a hand wheel of the steering system by controlling, by a control module, a motor of an active steering system.

In one embodiment, a system includes a first module that determines that an automated steering event is occurring. A second module minimizes motion of a hand wheel of the steering system by controlling a motor of an active steering system.

In one embodiment, a vehicle includes an active steering system and a control module. The control module determines that an automated steering event is occurring, and minimizes motion of a hand wheel of the steering system by controlling a motor of an active steering system.

### DESCRIPTION OF THE DRAWINGS

The present disclosure will hereinafter be described in conjunction with the following drawing figures, wherein like numerals denote like elements, and:

FIG. 1 is a functional block diagram of a vehicle that includes, among other features, a steering system, and a control system for controlling the steering system, in accordance with various exemplary embodiments;

FIG. 2 is a data flow diagram of a control module associated with steering system in accordance with various exemplary embodiments;

FIG. 3 is a flowchart of a method for controlling a steering system in accordance with various exemplary embodiments;

FIG. 4 is a data flow diagram of a control module associated with steering system in accordance with various exemplary embodiments; and

FIG. 5 is a flowchart of a method for controlling a steering system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

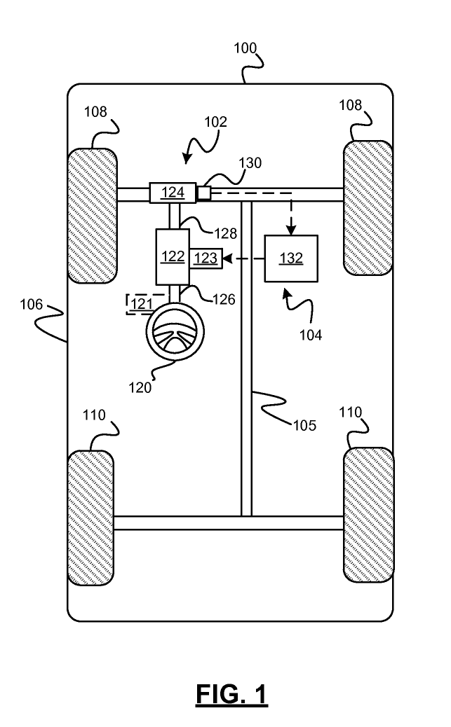

Referring now to FIG. 1, a vehicle 100 is shown to include a steering system 102 and a control system 104 that controls the steering functionality using, among other factors, motion control if the hand wheel in accordance with various embodiments. Although the figures shown herein depict an example with certain arrangements of elements, additional intervening elements, devices, features, or components may be present in an actual embodiments. It should also be understood that FIG. 1 is merely illustrative and may not be drawn to scale.

As depicted in FIG. 1, the vehicle 100 generally includes a chassis 105, a body 106, front wheels 108, rear wheels 110, the steering system 102, and the control system 104. The body 106 is arranged on the chassis 105 and substantially encloses the other components of the vehicle 100. The body 106 and the chassis 105 may jointly form a frame. The wheels 108-110 are each rotationally coupled to the chassis 105 near a respective corner of the body 106.

As can be appreciated, the vehicle 100 may be any one of a number of different types of vehicle, and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

The steering system 102 generally includes a hand wheel 120, an active steering system 122, and a gear system 124. As shown in FIG. 1, in accordance with various embodiments, the hand wheel 120 is coupled to a steering column 126; the active steering system 122 is coupled between the steering column 126 and an intermediate shaft 128; and the gear system 124 is coupled to the intermediate shaft 128. As can be appreciated, the arrangements of the components 120-128 can vary in various embodiments, for example, the active steering system 122 can be alternatively located within or as a part of the hand wheel 120, located as a part of the steering column 126, or located as part of the gear system 124. For exemplary purposes, the exemplary embodiments will be discussed in the context of the active steering system 122 being located between the steering column 126 and the intermediate shaft 128 a shown.

In various embodiments, the active steering system 122 includes one or more gear sets and a motor 123. The motor 123 is electronically controlled to adjust the steering ratio between the steering column 126 and the intermediate shaft 128. In particular, the motor 123 is controlled to control the gear sets to add to or to subtract from the angle of the steering column 126.

In various embodiments, the gear system 124 is a rack and pinion assembly that includes a rack, a pinion, and one or more tie rods. The gear system 124 is part of an Electric Power Steering System (EPS) that includes an electric motor that is electronically controlled. During certain automated steering events (e.g., crash avoidance, etc.), the gear system 124 is controlled to automatically steer the road wheels 108 in a certain direction (e.g., in a direction to avoid a crash). In particular, a position of the pinion is controlled during the automated steering event to steer the road wheels 108. While embodiments of the gear system 124 are discussed as electric rack and pinion systems, in certain other embodiments other types of steering systems may be used, such as other rack EPS systems (e.g., belt-drive, dual pinion, concentric, etc.), single pinion EPS systems, and column EPS systems, or other steering systems such as, but not limited to, hydraulic power steering (HPS) systems, and EPS systems having a recirculating ball mechanical linkage system instead.

The control system 104 generally controls the operation of the active steering system 122, among other things, such that movement of the hand wheel 120 is minimized during an automated steering event. For example, the control system includes 104 a control module 132 and one or more sensors 130. The sensors 130 sense observable conditions of the steering system 102. The sensors 130 include a position sensor that senses a position of the gear system 124. For example, the position sensor senses the position of the pinion in the gear system 124 and generates a sensor signal based thereon. When an automated steering event occurs (e.g., when the EPS gear system 124 is actively steering the road wheels 108), the control module 132 receives the position signal and determines a hand wheel offset based thereon.

The control module 132 determines the active steering offset to control the motor of the active steering system 122 such that a desired hand wheel offset is produced. The value of the active steering offset can be determined to produce full hand wheel movement, partial hand wheel movement, or no hand wheel movement. For example, as shown in the following table, the hand wheel offset is the difference between the pinion offset and the active steering offset.

TABLE 1

| Pinion Offset | Desired Motion | | Active Steering | Hand Wheel Offset |
|---|---|---|---|---|
| (degrees) | Reduction | | Offset (degrees) | (degrees) |
| 100 | None | (0%) | 0 | 100 |
| 100 | Partial | (80%) | 80 | 20 |
| 100 | Full | (100%) | 100 | 0 |

Thus, in various embodiments, the control module 132 determines the hand wheel active steering offset based on the following relation:

Active Steering Offset=(Pinion Offset)*(Desired Percent Motion Reduction).

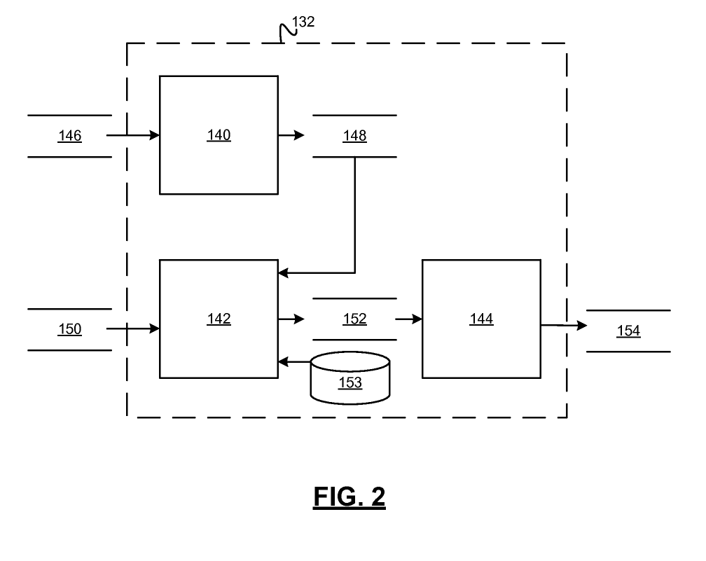

Referring now to FIG. 2 and with continued reference to FIG. 1, a dataflow diagram illustrates various embodiments of the control module 132. Various embodiments of the control module 132 according to the present disclosure may include any number of sub-modules. As can be appreciated, the sub-modules shown in FIG. 2 may be combined and/or further partitioned to similarly control the active steering system 122 such that hand wheel movement is reduced during an automated steering event. Inputs to the control module 132 may be received from the sensors 130, received from other control modules (not shown) of the vehicle 100, and/or determined by other sub-modules (not shown) of the control module 132. In various embodiments, the control module 132 includes an automated steering event determination module 140, an active steering offset determination module 142, and an automated steering system control module 144.

The automated steering event determination module 140 receives as input various steering data 146. Based on the steering data 146, the automated steering event determination module 140 determines whether or not an automated steering event is occurring or is about to occur and sets an automated steering event status flag 148 based thereon. For example, when the automated steering event determination module 140 determines that an automated steering event is occurring, the automated steering event determination module 140 sets the automated steering event status flag 148 to indicate TRUE or automated steering. In another example, when the automated steering event determination module 140 determines that an automated steering event is not occurring, the automated steering event determination module 140 sets the automated steering event status flag 148 to indicate FALSE or no automated steering.

In various embodiments, the automated steering event determination module 140 further determines whether the automated steering event is an event with high road wheel steering rates (e.g., categorized as high, or having a steering rate above a threshold) and sets the automated steering event status flag 148 based thereon. For example, when the automated steering event determination module 140 determines that an automated steering event with high road wheel steering rates is occurring, the automated steering event determination module 140 sets the automated steering event status flag 148 to indicate TRUE or automated steering. In another example, when the automated steering event determination module 140 determines that an automated steering event with low (not high) road wheel steering rates is occurring, the automated steering event determination module 140 sets the automated steering event status flag 148 to indicate FLASE or no automated steering.

The active steering offset determination module 142 receives as input the automated steering event status flag 148 and pinion offset data 150. The pinion offset data 150 may be sensed by the position sensor 130. Based on the inputs, the active steering offset determination module 142 determines an active steering offset 152. For example, when the automated steering event status flag 148 indicates TRUE or automated steering, the active steering offset determination module 142 determines the active steering offset 152 based on the pinion offset data 150 and the desired motion reduction. The desired motion reduction may be predetermined and retrieved from a datastore 153. In another example, when the automated steering event status flag 148 indicates FALSE or no automated steering, the active steering offset determination module 142 determines the active steering offset 152 to be zero.

The automated steering system control module 144 receives as input the active steering offset 152. Based on the active steering offset 152, the automated steering system control module 144 generates a control signal 154 to the motor of the active steering system 122 to control the motor such that the movement of the steering column 126 and the hand wheel 120 is reduced according to the desired motion reduction.

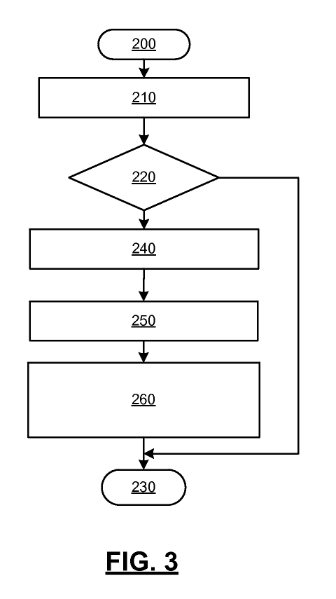

Referring now to FIG. 3, and with continued reference to FIGS. 1 and 2, a flowchart illustrates a control method that can be performed by the steering system and control system of FIGS. 1 and 2 in accordance with various embodiments. As can be appreciated in light of the disclosure, the order of operation within the method is not limited to the sequential execution as illustrated in FIG. 3, but may be performed in one or more varying orders as applicable and in accordance with the present disclosure.

As can further be appreciated, the method of FIG. 3 may be scheduled to run at predetermined time intervals during operation of the vehicle 200 and/or may be scheduled to run based on predetermined events.

In one example, the method may begin at 200. The steering data 146 is received at 210 and evaluated at 220. If the steering data 146 indicates an automated steering event is not occurring, the method may end at 230. If, however, the steering data 146 indicates that an automated steering event (with or without high steering rates) is occurring, the active steering offset 152 is determined at 240 (e.g., based on the relation discussed above). The control signals 154 are generated based on the active steering offset 152 at 250. The motor of the active steering system 122 minimizes the rotation of the steering column 126 and the hand wheel 120 based on the control signals 154 at 260. Thereafter, the method may end at 230.

With reference back to FIG. 1, in various embodiments, when the gear system 124 fails, it is desirable to continue the automated steering of the road wheels 108 (regardless of whether the movement of the hand wheel 120 is being controlled). In such a case, the steering system 102 further includes a friction device 121 shown in phantom. As shown in FIG. 1, the friction device 121 is a column friction device that is implemented as part of the steering column 126. As can be appreciated, as discussed above, the arrangements of the components 120-130 including the friction device 121 can vary in various embodiments.

In such embodiments, the control system 104 generally controls the operation of the active steering system 122, among other things, such that steering of the road wheels 108 can be automatically controlled during the failure of the gear system 124. For example, the control system includes 104 a control module 132 and one or more sensors 130. The sensors 130 sense observable conditions of the steering system 102. In various embodiments, the sensors 130 include the position sensor that senses a position of the gear system 124 and that generates a sensor signal based thereon. In various embodiments, the sensors 130 include image sensors or other sensors that sense a vehicle path (e.g., sensors of a lane detection system). It can be determined from at least some of the sensor signals (among other things), whether the gear system 124 is working as intended or whether a failure is occurring. The control module 132 controls the active steering system 122 when an automated steering event occurs (e.g., when the EPS gear system 124 is being controlled to actively steering the road wheels 108) and an EPS failure occurs. The control module 132 controls the active steering system 122 such that the steering of the road wheels 108 is continued. For example, the control module 132 controls the motor of the active steering system 122 such that a desired steering angle is achieved by the intermediate shaft 128. In various embodiments, the desired steering angle can be determined from the image sensors or other means.

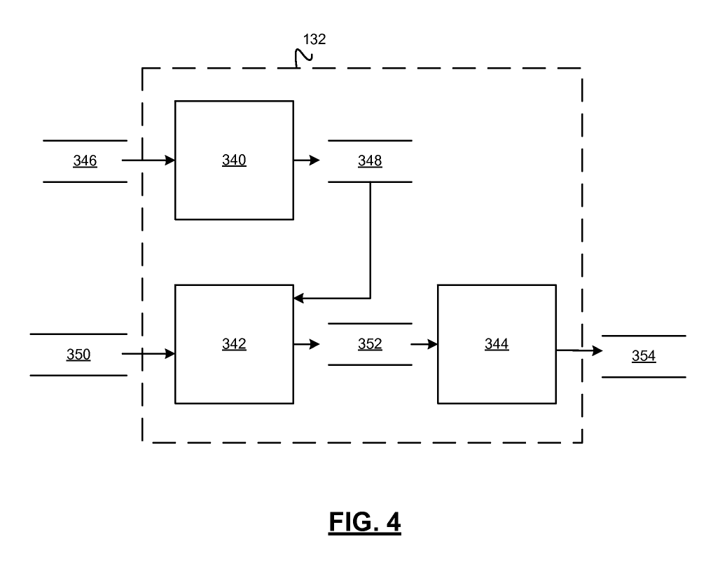

Referring now to FIG. 4 and with continued reference to FIG. 1, a dataflow diagram illustrates various embodiments of the control module 132. Various embodiments of the control module 132 according to the present disclosure may include any number of sub-modules. As can be appreciated, the sub-modules shown in FIG. 4 may be combined and/or further partitioned to similarly control the active steering system 122 such that automated steering is achieved during failure of the gear system 124. As can further be appreciated, the sub-modules shown in FIG. 4 may be provided in addition to the sub-modules shown in FIG. 2 or as an alternative to the sub-modules of FIG. 2. Inputs to the control module 132 may be received from the sensors 130, received from other control modules (not shown) of the vehicle 100, and/or determined by other sub-modules (not shown) of the control module 132. In various embodiments, the control module 132 includes an automated steering event determination module 340, a control signal determination module 342, and an active steering device control module 344.

The automated steering event determination module 340 receives as input various steering data 346. Based on the steering data 346, the automated steering event determination module 340 determines whether or not an automated steering event is occurring and whether there exists a failure in the gear system 124. The automated steering event determination module 340 sets an active steering system automated steering event status flag 348 based thereon. For example, when the automated steering event determination module 340 determines that an automated steering event is occurring and that a failure exists in the gear system 124, the automated steering event determination module 340 sets the active steering system automated steering event status flag 348 to indicate TRUE or activate automated steering of the active steering system. In another example, when the automated steering event determination module 340 determines that an automated steering event is not occurring or that a failure does not exist in the gear system 124, the automated steering event determination module 340 sets the active steering system automated steering event status flag 348 to indicate FLASE or do not activate the automated steering.

The control signal determination module 342 receives as input the active steering system automated steering event status flag 348 and a desired road wheel angle 350. The desired road wheel angle indicates a desired steering angle of the road wheel 180 (e.g., to avoid a crash). Based on the inputs, the control signal determination module 342 determines a control value 352 for controlling the active steering system 122 such that it produces a desired steering angle of the intermediate shaft 128. For example, when the active steering system automated steering event status flag 348 indicates TRUE or activate automated steering, the control signal determination module 342 determines the control value 352 based on the desired road wheel angle 350. In another example, when the automated steering event status flag 348 indicates FALSE or no automated steering, the control signal determination module 342 determines the control value 352 to be zero.

The active steering device control module 344 receives as input the control value 352. Based on the control value 352, the active steering device control module 344 generates a control signal 354 to the motor of the active steering system 122 to control the motor such that the intermediate shaft 128 is controlled to the desired angle thereby controlling the steering angle of the road wheels 108.

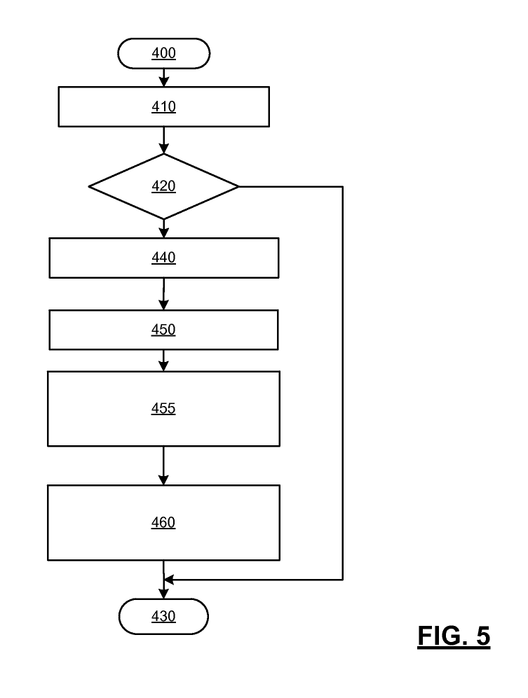

Referring now to FIG. 5, and with continued reference to FIGS. 1 and 4, a flowchart illustrates a control method that can be performed by the steering system and control system of FIGS. 1 and 4 in accordance with various embodiments. As can be appreciated in light of the disclosure, the order of operation within the method is not limited to the sequential execution as illustrated in FIG. 5, but may be performed in one or more varying orders as applicable and in accordance with the present disclosure.

As can further be appreciated, the method of FIG. 5 may be scheduled to run at predetermined time intervals during operation of the vehicle 100 and/or may be scheduled to run based on predetermined events.

In one example, the method may begin at 400. The steering data 346 is received at 410 and evaluated at 420. If the steering data 346 indicates an automated steering event is not occurring or that the gear assembly has not failed at 420, the method may end at 430. If, however, the steering data 346 indicates that an automated steering event is occurring and that the gear system 124 is failing, the control value 352 is determined at 440. The control signals 354 are generated based on the control value 352 at 450. At 455, the friction device is activated to accommodate a hand-off driving scenario. The motor of the active steering system 122 controls the angle of the intermediate shaft 128 based on the control signals 354 at 460 such that the road wheels 108 can continue to be steered during the automated steering event. Thereafter, the method may end at 430.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of controlling a steering system of a vehicle, the method comprising:
determining that an automated steering event is occurring; and
minimizing motion of a hand wheel of the steering system by controlling, by a control module, a motor of an active steering system.

2. The method of claim 1, further comprising:
determining, by the control module, an active steering offset based on a pinion offset and a desired motion reduction value, and
wherein the controlling the motor of the active steering system is based on the active steering offset.

3. The method of claim 2, wherein the pinion offset is a measured pinion offset that is measured from a gear system of the steering system.

4. The method of claim 2, wherein the desired motion reduction value is a percentage value.

5. The method of claim 2, wherein the determining the active steering offset is based on the following relation:
Active Steering Offset=(Pinion Offset)*(Desired Percent Motion Reduction).

6. The method of claim 2, further comprising generating a control signal to control the motor of the active steering system based on the active steering offset.

7. The method of claim 1, wherein the determining that an automated steering event is occurring further comprises determining that an automated steering event with a determined steering rate is occurring.

8. A system for controlling a steering system of a vehicle, the system comprising:
a first module that determines that an automated steering event is occurring; and
a second module that minimizes motion of a hand wheel of the steering system by controlling a motor of an active steering system.

9. The system of claim 8 further comprising:
a third module that determines an active steering offset based on a pinion offset and a desired hand wheel motion reduction value, and
wherein the second module controls the motor of the active steering system based on the active steering offset.

10. The system of claim 9, wherein the pinion offset is a measured pinion offset that is measured from a gear system of the steering system.

11. The system of claim 9, wherein the desired motion reduction value is a percentage value.

12. The system of claim 9, wherein the third module determines the active steering offset based on the following relation:
Active Steering Offset=(Pinion Offset)*(Desired Percent Motion Reduction).

13. The system of claim 9, wherein the second module controls the motor by generating a control signal to control the motor of the active steering system based on the active steering offset.

14. The system of claim 9, wherein the first module determines that an automated steering event is occurring further by determining that an automated steering event with a determined steering rate is occurring.

15. A vehicle, comprising:
an active steering system; and
a control module that determines that an automated steering event is occurring, and that minimizes motion of a hand wheel of the steering system by controlling a motor of an active steering system.

16. The vehicle of claim 15, wherein the control module determines an active steering offset based on a pinion offset and a desired motion reduction value, and controls the motor of the active steering system based on the active steering wheel offset.

17. The vehicle of claim 16, wherein the pinion offset is a measured pinion offset that is measured from a gear system of the steering system.

18. The vehicle of claim 16, wherein the desired motion reduction value is a percentage value.

19. The vehicle of claim 16, wherein the control module controls the motor by generating a control signal to control the motor of the active steering system based on the active steering offset.

20. The vehicle of claim 16, wherein the control module determines that an automated steering event is occurring further by determining that an automated steering event with a determined steering rate is occurring.
